(19) United States
(12) Patent Application Publication
(10) Pub. No.: US 2026/0163147 A1
(43) Pub. Date: Jun. 11, 2026

(54) BATTERY MODULE AND METHOD FOR MANUFACTURING BATTERY MODULE

(71) Applicant: SK ON CO., LTD., Seoul (KR)

(72) Inventor: Hyun Seok KIM, Daejeon (KR)

(21) Appl. No.: 19/313,785

(22) Filed: Aug. 28, 2025

(30) Foreign Application Priority Data
Dec. 10, 2024 (KR) 10-2024-0182940

(51) Int. Cl. H01M 50/233; H01M 50/211; H01M 50/271; H01M 50/503; H01M 50/507

(52) U.S. Cl. CPC H01M 50/233; H01M 50/211; H01M 50/271; H01M 50/503; H01M 50/507

(57) ABSTRACT

A battery module according to an aspect of the present disclosure includes a plurality of sub-battery assemblies spaced apart from each other in a front-back direction; and a case assembly configured to accommodate the plurality of sub-battery assemblies, wherein the case assembly is formed to extend in the front-back direction and includes a side case that forms a side surface of the case assembly, and the side case is disposed on the side surfaces of the plurality of sub-battery assemblies.

### CROSS-REFERENCE TO RELATED APPLICATIONS

This application claims priority to Korean Patent Application No. 10-2024-0182940 filed on Dec. 10, 2024, in the Korean Intellectual Property Office (KIPO), the entire disclosure of which is incorporated by reference herein.

### BACKGROUND OF THE INVENTION

### 1. Field of the Invention

The present disclosure relates to a battery module and a method for manufacturing a battery module.

### 2. Description of the Related Art

A secondary battery includes cylindrical, pouch-type, and prismatic-type batteries, and the pouch-type battery cell may be classified into a unidirectional-type battery cell and a bidirectional-type battery cell depending on the direction in which the tabs protrude. Due to various advantages, pouch-type battery cells with bidirectional tabs are mainly used.

A battery module may be manufactured using pouch-type battery cells. For example, after a plurality of pouch-type battery cells are stacked between a pair of plates, a sub-module may be formed in which the cell tabs of the battery cells are connected to a busbar.

### SUMMARY OF THE INVENTION

According to the present disclosure, a battery module that can enhance structural rigidity may be provided.

A battery module according to an aspect of the present disclosure may include: a plurality of sub-battery assemblies spaced apart from each other in a front-back direction; and a case assembly configured to accommodate the plurality of sub-battery assemblies, wherein the case assembly may be formed to extend in the front-back direction and may include a side case that forms a side surface of the case assembly, and the side case may be disposed on the side surfaces of the plurality of sub-battery assemblies.

In exemplary embodiments, the side case may include: a first side case disposed on one side of the plurality of sub-battery assemblies; and a second side case disposed on the other side of the plurality of sub-battery assemblies.

In exemplary embodiments, the plurality of sub-battery assemblies may include: a first sub-battery assembly; and a second sub-battery assembly disposed behind the first sub-battery assembly in the front-back direction.

In exemplary embodiments, each of the side cases may be formed as a single integrated member.

In exemplary embodiments, the case assembly may include: a center case disposed between the plurality of sub-battery assemblies, wherein the center case may be coupled to the side case.

In exemplary embodiments, the case assembly may further include: a lower case disposed below the plurality of sub-battery assemblies; an upper case disposed above the plurality of sub-battery assemblies; a front case disposed in front of the first sub-battery assembly; and a rear case disposed behind the second sub-battery assembly.

In exemplary embodiments, each of the plurality of sub-battery assemblies may include: a cell assembly having a plurality of battery cells stacked in a left-right direction; and at least one busbar assembly coupled to the cell assembly.

In exemplary embodiments, the at least one busbar assembly may include: a busbar coupled to the cell assembly in the left-right direction; and a busbar jig configured to join the busbar and the cell assembly.

In exemplary embodiments, a pair of busbar assemblies may be provided, and the pair of busbar assemblies may be disposed in front and behind the cell assembly in the front-back direction.

In exemplary embodiments, the pair of busbar assemblies may be symmetrically arranged with respect to the cell assembly.

In exemplary embodiments, each of the plurality of battery cells may include: a cell body that defines an external appearance of the battery cell; and battery cell tabs formed on both sides of the cell body in a longitudinal direction of the battery cell.

In exemplary embodiments, the cell assembly may further include cell pads disposed between the plurality of battery cells and stacked in the left-right direction.

In exemplary embodiments, a plurality of center cases may be provided, and the plurality of center cases may be spaced apart from each other in the front-back direction.

In exemplary embodiments, the center case and the side case may be coupled by welding.

In exemplary embodiments, one end of the center case may be inserted into a case hole that penetrates the side case, and a wall of the case hole facing the inserted end of the center case may be welded to the inserted end.

In exemplary embodiments, prior to coupling the side case to the sub-battery assembly, an assembly jig coupled to the sub-battery assembly may be removed.

A method for manufacturing a battery module according to another aspect of the present disclosure may include: mounting a cell assembly, in which battery cells are stacked, onto an assembly jig; coupling a busbar assembly to the cell assembly to form a sub-battery assembly; arranging a pair of sub-battery assemblies spaced apart from each other in a front-back direction; removing a left panel and a right panel of the assembly jig disposed on both sides of the cell assembly in the stacking direction of the battery cells; and arranging side cases on side surfaces of the pair of sub-battery assemblies in the front-back direction.

In exemplary embodiments, the method may further include arranging a center case between the sub-battery assemblies, wherein the center case may be coupled to the side cases.

In exemplary embodiments, the center case and the side case may be coupled by welding.

In exemplary embodiments, one end of the center case may be inserted into a case hole formed in the side case, and a wall of the case hole facing the inserted end of the center case may be welded to the inserted end.

The battery module according to an embodiment of the present disclosure may reinforce structural rigidity through side cases that are simultaneously coupled to a plurality of sub-battery assemblies disposed in one direction.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is an exploded perspective view illustrating a battery module according to an embodiment of the present disclosure;

FIG. 2 is a perspective view illustrating the assembled battery module of FIG. 1;

FIG. 3 is a cross-sectional view of the battery module taken along line A1-A2 of FIG. 2;

FIG. 4 is a perspective view illustrating a battery cell according to an embodiment of the present disclosure;

FIG. 5 is a perspective view illustrating a cell assembly according to an embodiment of the present disclosure;

FIG. 6 is a view illustrating a state in which an assembly jig left panel is disposed on one side of the cell assembly;

FIG. 7 is a view illustrating a state in which an assembly jig right panel is additionally disposed on the opposite side of the cell assembly;

FIG. 8 is a view illustrating a state in which a busbar assembly is coupled to the cell assembly mounted on an assembly jig;

FIG. 9 is a plan view illustrating a state in which a pair of busbar assemblies are coupled to the cell assembly;

FIG. 10 is a plan view illustrating a pair of sub-battery assemblies and a center case disposed between the pair of sub-battery assemblies;

FIG. 11 is a plan view illustrating a state in which a left panel of the assembly jig and a right panel of the assembly jig are separated from the sub-battery assemblies;

FIG. 12 is a cross-sectional view illustrating a state in which a center case and side cases are joined using a coupling member;

FIG. 13 is a cross-sectional view illustrating a state in which the center case and the side case are joined using a welding unit;

FIG. 14 is a cross-sectional view illustrating a state in which welding is performed on the center case inserted into a case hole formed in the side case; and

FIG. 15 is a cross-sectional view of the battery module taken along line A1-A2 of FIG. 2, showing a pair of center cases disposed between the pair of sub-battery assemblies.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to facilitate understanding of the relationship between an element or feature and another illustrated in the drawings. These space-related terms are provided to facilitate understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

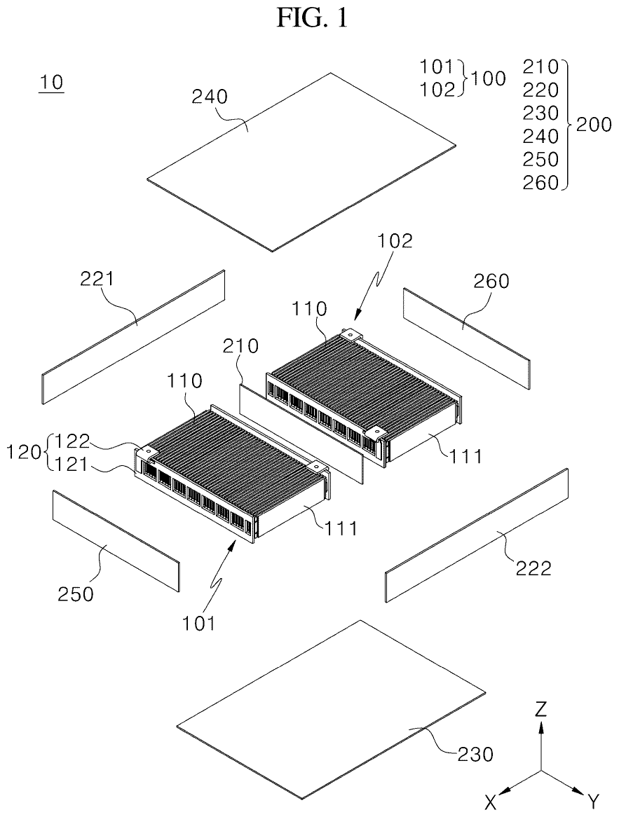

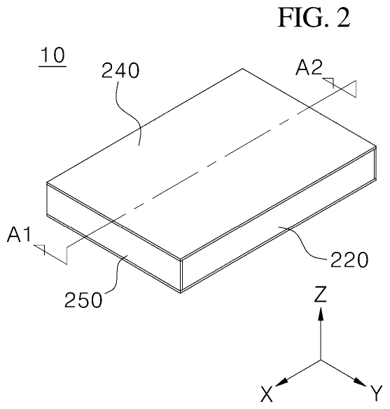

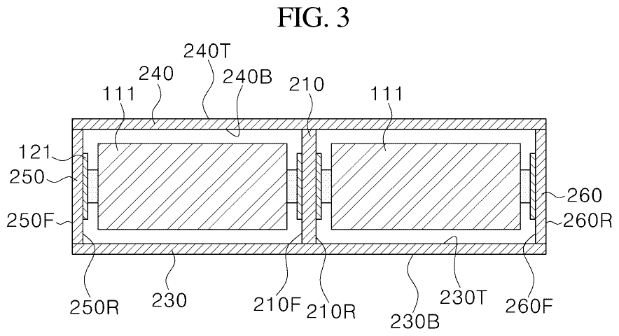

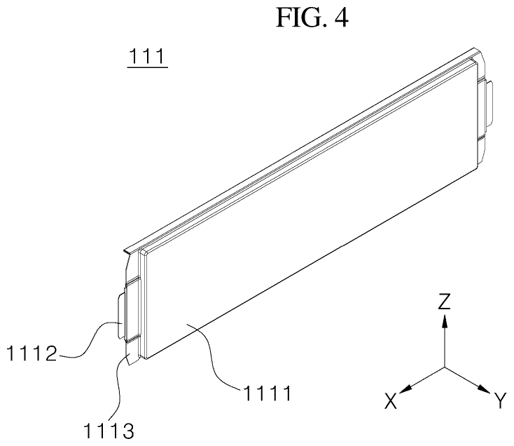

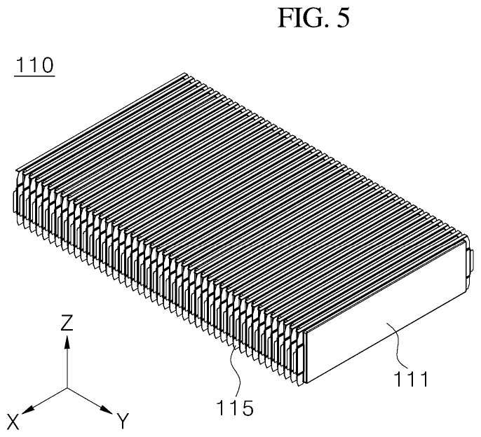

Hereinafter, battery modules according to various embodiments of the present disclosure will be described in detail with reference to FIGS. 1 to 15.

The battery module of the present disclosure may be applied to pouch cells, cylindrical cells, prismatic cells, etc. The electrode assembly may be a winding-type, a stacking-type, a z-folding-type, or a stacked-folding type.

In the present specification, the up-down, left-right, and front-back directions may be set based on FIG. 1.

The front-back direction may be parallel to the X-axis. For example, a positive X-axis direction may represent the forward direction, and a negative X-axis direction may represent the rearward direction.

The up-down direction may be parallel to the Z-axis. For example, a positive Z-axis direction may represent the upward direction, and a negative Z-axis direction may represent the downward direction.

The left-right direction may be parallel to the Y axis. For example, a positive Y-axis direction may represent the right side, and a negative Y-axis direction may represent the left side. The Y-axis may be perpendicular to the X-axis and the Z-axis, respectively.

Referring to FIGS. 1 to 5, a battery module 10 may include a case assembly 200. The case assembly 200 may form a hollow shape. For example, the case assembly 200 may be formed in a hollow cuboidal shape. The case assembly 200 may be formed to extend in one direction. For example, the case assembly 200 may be formed in an elongated shape in the front-back direction.

The battery module 10 may include a battery assembly 100. The battery assembly 100 may include at least one battery cell 111. The battery cell 111 may extend in the longitudinal direction of the battery module 10. For example, the battery cell 111 may extend in the front-back direction.

The battery assembly 100 may include at least one cell pad 115. The cell pad 115 may extend in the longitudinal direction of the battery module 10. For example, the cell pad 115 may extend in the front-back direction. The cell pad 115 may be disposed between the battery cells 111. The cell pad 115 may be stacked in the left-right direction. For example, the cell pad 115 may be disposed between a plurality of battery cells 111.

The battery cell 111 may include a cell body 1111, battery cell tabs 1112, and a cell pouch 1113. The cell pouch 1113 may have a structure that encloses the electrode assembly. The battery cell tabs 1112 may be formed to protrude from opposite ends of the electrode assembly in the longitudinal direction of the cell body 1111.

The cell body 1111 may form at least a portion of an outer surface of the battery cell 111. The cell body 1111 may include an electrode receiving part configured to accommodate the electrode assembly and a sealing part for sealing at least a portion of the periphery of the electrode receiving part. The electrode receiving part may be formed in a container-like shape. The electrode receiving part may provide a space in which the electrode assembly and an electrolyte are accommodated.

The battery cell tabs 1112 may be disposed on opposite sides in the longitudinal direction of the battery cell 111. For example, a battery cell tab 1112 of a first polarity (e.g., a positive electrode) may be disposed on one side in the longitudinal direction of the battery cell 111, and another battery cell tab 1112 of a second polarity (e.g., a negative electrode) may be disposed on the other side in the longitudinal direction.

However, this is merely illustrative, and the direction in which the battery cell tabs 1112 are positioned may be arbitrarily designed. For example, the battery cell tabs 1112 of the first polarity and the second polarity may be disposed together on either side in the longitudinal direction of the battery cell 111.

The cell pouch 1113 may be formed of a single sheet of outer material. For example, the cell pouch 1113 may be formed by folding the outer material after one or two accommodation parts are formed on a single sheet of the outer material, and then the accommodation parts may provide a single space (e.g., the electrode receiving part).

A plurality of battery cells 111 may be stacked in one direction. For example, the plurality of battery cells 111 may be stacked in the transverse direction of the battery module 10. For example, the transverse direction of the battery module 10 may be parallel to the left-right direction or the Y-axis. The plurality of stacked battery cells 111 may form a cell assembly 110.

A plurality of cell assemblies 110 may form the battery assembly 100. The plurality of battery cells 111 forming each of the plurality of cell assemblies 110 may be stacked in the transverse direction of the battery module 10.

A plurality of battery assemblies 100 may be provided. For example, the battery module 10 may include a plurality of sub-battery assemblies 101 and 102. For example, the battery module 10 may include a pair of sub-battery assemblies 101 and 102. The pair of sub-battery assemblies 101 and 102 may be stacked in the longitudinal direction of the battery module 10.

Each of the pair of sub-battery assemblies 101 and 102 may include a plurality of cell assemblies 110. A first sub-battery assembly 101 may include the cell assembly 110 stacked in the transverse direction of the battery module 10. A second sub-battery assembly 102 may also include the cell assembly 110 stacked in the transverse direction of the battery module 10.

The pair of sub-battery assemblies 101 and 102 may be spaced apart from each other in the longitudinal direction of the battery module 10. A center case 210 may be disposed between the pair of sub-battery assemblies 101 and 102.

The battery assembly 100 may include a busbar assembly 120. The busbar assembly 120 may form a front surface of each of the sub-battery assemblies 101 and 102. The busbar assembly 120 may form a rear surface of each of the sub-battery assemblies 101 and 102.

The busbar assembly 120 may be connected or coupled to the cell assembly 110 forming the sub-battery assemblies 101 and 102. The busbar assembly 120 may be formed in the transverse direction of the battery module 10.

The busbar assembly 120 may include a busbar 121. The busbar 121 may be connected to the battery cell tabs 1112 of the plurality of battery cells 111. That is, the plurality of battery cells 111 may be electrically connected in parallel or series by the busbar 121.

The busbar assembly 120 may include a busbar jig 122. The busbar jig 122 may be connected or coupled to the busbar 121. The busbar jig 122 may be connected or coupled to the busbar 121 and the cell assembly 110. A plurality of busbar jigs 122 may be provided.

The busbar jigs 122 may be disposed diagonally relative to the busbar 121. For example, one of the plurality of busbar jigs 122 may be connected to an upper left end of the busbar 121 and an upper left surface of the cell assembly 110. For example, another of the busbar jigs 122 may be connected to a lower right end of the busbar 121 and a lower right surface of the cell assembly 110.

The battery module 10 may include the case assembly 200. The case assembly 200 may accommodate the battery assembly 100. The outermost battery cell 111 forming the battery assembly 100 may face or be oriented toward the inner surface of the case assembly 200.

The case assembly 200 may include a center case 210. The center case 210 may be formed to extend in one direction. The center case 210 may extend from one end to the other end.

For example, the center case 210 may extend from one end to the other end in the transverse direction of the battery module 10. The center case 210 may be formed in a plate or board shape.

The center case 210 may be disposed between the plurality of sub-battery assemblies 101 and 102. For example, the center case 210 may be disposed between the pair of sub-battery assemblies 101 and 102. The center case 210 may include a center case front portion 210F.

The center case front portion 210F may face or be oriented toward a rear surface of the first sub-battery assembly 101 disposed in front of the pair of battery assemblies 100. The center case 210 may include a center case rear portion 210R. The center case rear portion 210R may face or be oriented toward a front surface of the second sub-battery assembly 102 disposed behind the pair of battery assemblies 100.

The center case 210 may partition a space of the case assembly 200. That is, the center case 210 may divide an internal space of the case assembly 200 into front and rear sections. The pair of sub-battery assemblies 101 and 102 may be disposed, respectively, in the internal space of the case assembly 200 divided into the front and rear sections.

The case assembly 200 may include a side case 220. The side case 220 may extend in one direction. The side case 220 may be formed to extend from one end to the other end.

For example, the side case 220 may extend from one end to the other end in the longitudinal direction of the battery module 10. The side case 220 may be formed in a plate or board shape.

The side case 220 may be formed as a single member. That is, the side case 220 may be a continuous member having a single material. Conventionally, side cases were coupled and used for each of a plurality of battery assemblies 100, which may have been vulnerable to insufficient rigidity of the large battery module.

Meanwhile, in the present disclosure, the side case 220 may be formed as a single integrated member in the battery module 10 having the pair of sub-battery assemblies 101 and 102. Through this, the structural rigidity of the battery module 10 may be enhanced.

A pair of side cases 220 may be provided. The pair of side cases 220 may form both side surfaces of the case assembly 200 in the left-right direction. The pair of sub-battery assemblies 101 and 102 and the center case 210 may be disposed between the pair of side cases 220.

The side cases 220 may include a first side case 221 and a second side case 222. The first side case 221 and the second side case 222 may be disposed side by side and spaced apart from each other. The first side case 221 may be referred to as a “left side case.” The second side case 222 may be referred to as a “right side case.”

The first side case 221 may form the left side surface of the case assembly 200. An inner surface of the first side case 221 may face or be directed toward side surfaces of the pair of sub-battery assemblies 101 and 102 and a side surface of the center case 210. For example, the first side case 221 may face the left side surface of the pair of sub-battery assemblies 101 and 102 and the left side surface of the center case 210.

The second side case 222 may form the right side surface of the case assembly 200. An inner surface of the second side case 222 may face or be directed toward side surfaces of the pair of sub-battery assemblies 101 and 102 and a side surface of the center case 210. For example, the second side case 222 may face the right side surfaces of the pair of sub-battery assemblies 101 and 102 and the right side surface of the center case 210.

The case assembly 200 may include a lower case 230. The lower case 230 may form a bottom surface of the case assembly 200. The lower case 230 may include a top surface portion 230T. The top surface portion 230T of the lower case 230 may face or be oriented toward a bottom surface of the battery assembly 100.

The lower case 230 may include a bottom surface portion 230B. The bottom surface portion 230B of the lower case 230 may face or be oriented downward. The lower case 230 may be connected to the side cases 220. For example, both lateral ends of the lower case 230 in the left-right direction may be connected or coupled to lower ends of the side cases 220.

The case assembly 200 may include an upper case 240. The upper case 240 may form a top surface of the case assembly 200. The upper case 240 may include a bottom surface portion 240B. The bottom surface portion 240B of the upper case 240 may face or be directed toward a top surface of the battery assembly 100.

The upper case 240 may include a top surface portion 240T. The top surface portion 240T of the upper case 240 may face or be oriented upward. The upper case 240 may be connected to the side cases 220. For example, both lateral ends of the upper case 240 in the left-right direction may be connected or coupled to upper ends of the side cases 220.

The case assembly 200 may include a front case 250. The front case 250 may form a front surface of the case assembly 200. The front case 250 may be formed to extend in one direction.

The front case 250 may extend from one end to the other end. For example, the front case 250 may extend from one end to the other end in the transverse direction of the battery module 10. The front case 250 may be formed in a plate or board shape.

Both lateral ends of the front case 250 may be connected or coupled to front ends of the side cases 220. For example, a left end of the front case 250 may be connected or coupled to a front end of the first side case 221. Likewise, a right end of the front case 250 may be connected or coupled to a front end of the second side case 222.

The front case 250 may include a rear surface portion 250R. The rear surface portion 250R of the front case 250 may face or be oriented toward a front surface of the first sub-battery assembly 101 disposed in front of the pair of battery assemblies 100. The front case 250 may include a front surface portion 250F. The front surface portion 250F of the front case 250 may face or be oriented forward.

The case assembly 200 may include a rear case 260. The rear case 260 may form a rear surface of the case assembly 200. The rear case 260 may be formed to extend in one direction.

The rear case 260 may extend from one end to the other end. For example, the rear case 260 may extend from one end to the other end in the transverse direction of the battery module 10. The rear case 260 may be formed in a plate or board shape.

Both lateral ends of the rear case 260 may be connected or coupled to rear ends of the side cases 220. For example, a left end of the rear case 260 may be connected or coupled to a rear end of the first side case 221. Likewise, a right end of the rear case 260 may be connected or coupled to a rear end of the second side case 222.

The rear case 260 may include a front surface portion 260F. The front surface portion 260F of the rear case 260 may face or be oriented toward a rear surface of the second sub-battery assembly 102 disposed behind the pair of battery assemblies 100. The rear case 260 may include a rear surface portion 260R. The rear surface portion 260R of the rear case 260 may face or be oriented rearward.

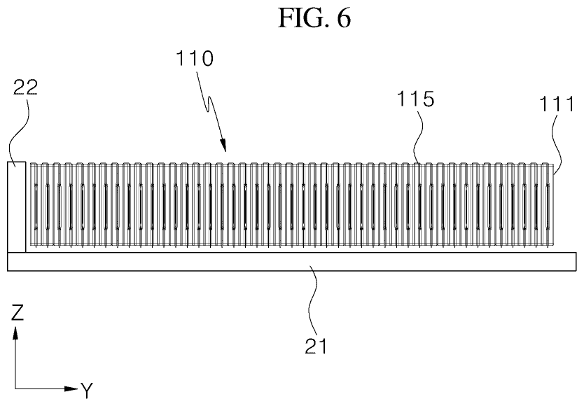

Hereinafter, a process for manufacturing the battery assembly 100 will be described with reference to FIGS. 6 to 9. The battery assembly 100 may be pre-assembled using an assembly jig 20.

The assembly jig 20 may include a lower panel 21, a left panel 22, and a right panel 23. The lower panel 21 of the assembly jig 20 may support the bottom surface of the battery assembly 100. The left panel 22 of the assembly jig 20 may be disposed on the left side of the battery assembly 100. The right panel 23 of the assembly jig 20 may be disposed on the right side of the battery assembly 100.

First, referring to FIG. 6, the cell assembly 110 forming the first sub-battery assembly 101 may be stacked in one direction on the lower panel 21 of the assembly jig 20. For example, the cell assembly 110 may be stacked in the transverse direction or the Y-axis direction of the battery module 10.

During the stacking process of the cell assembly 110, the left panel 22 of the assembly jig 20 may be disposed on one side of the lower panel 21 of the assembly jig 20. For example, the left panel 22 of the assembly jig 20 may be disposed at a left end of an upper surface of the lower panel 21 of the assembly jig 20. A front surface of the stacked cell assembly 110 may face or contact the right side of the left panel 22 of the assembly jig 20.

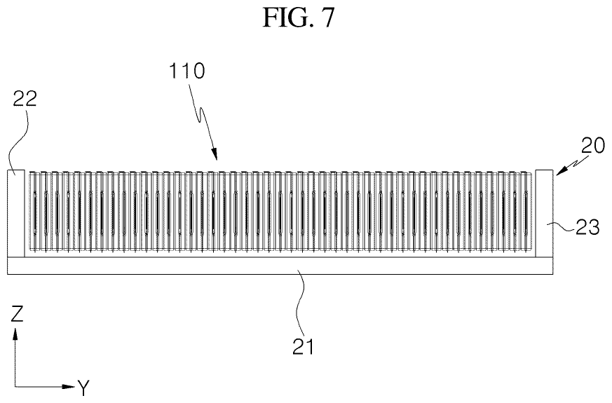

Referring to FIG. 7, during the stacking process of the first sub-battery assembly 101, the right panel 23 of the assembly jig 20 may be disposed on the opposite side of the cell assembly 110. For example, the right panel 23 of the assembly jig 20 may be disposed at a right end of the upper surface of the lower panel 21 of the assembly jig 20. A rear surface of the cell assembly 110 may face or contact the left side of the right panel 23 of the assembly jig 20.

The left panel 22 of the assembly jig 20 and the right panel 23 of the assembly jig 20 may be disposed on both sides of the plurality of stacked cell assemblies 110 in the transverse direction of the battery module 10. For example, the right panel 23 of the assembly jig 20 may be disposed on the side opposite to the left panel 22 of the assembly jig 20.

For example, the left panel 22 of the assembly jig 20 and the right panel 23 of the assembly jig 20 may be symmetrically arranged with respect to the plurality of cell assemblies 110. As a result, both ends of the plurality of stacked cell assemblies 110 may be pressed in the transverse direction of the battery module 10.

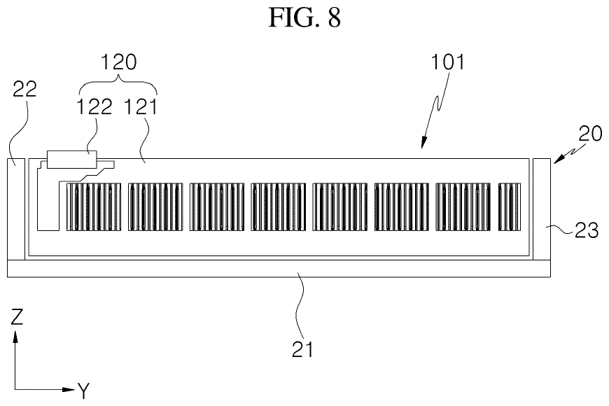

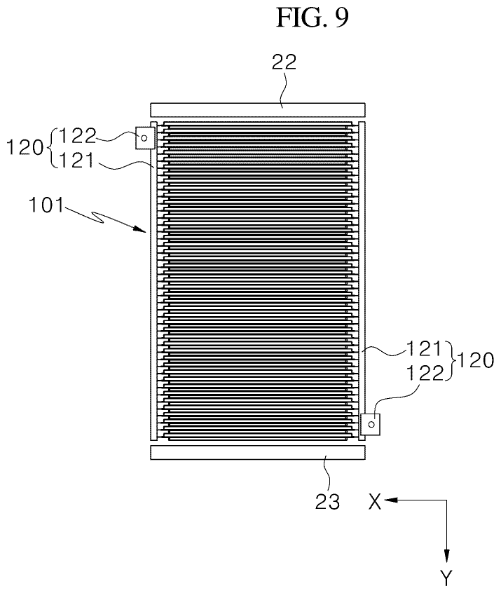

Referring to FIGS. 8 and 9, the busbar assembly 120 may be coupled to the plurality of stacked cell assemblies 110 (see FIG. 7). For example, the first sub-battery assembly 101 may include the plurality of cell assemblies 110 (see FIG. 7) and the busbar assembly 120. The busbar assembly 120 may be disposed between the left panel 22 of the assembly jig 20 and the right panel 23 of the assembly jig 20. A plurality of busbar assemblies 120 may be provided.

For example, a pair of busbar assemblies 120 may be disposed on both sides of the cell assembly 110 in the longitudinal direction. For example, the pair of busbar assemblies 120 may be coupled to the front and rear of each of the plurality of cell assemblies 110.

For example, the pair of busbar assemblies 120 may be disposed on opposite sides with respect to the plurality of cell assemblies 110. For example, the pair of busbar assemblies 120 may be disposed so as to be symmetrically arranged with respect to a transverse axis of the cell assembly 110.

The busbar assembly 120 may be disposed on the top surface of the lower panel 21 of the assembly jig 20. The busbar assembly 120 may be disposed so as to face the right panel 23 of the assembly jig 20 starting from the left panel 22 of the assembly jig 20.

Meanwhile, the second sub-battery assembly 102 may also be manufactured in the same manner as the first sub-battery assembly 101.

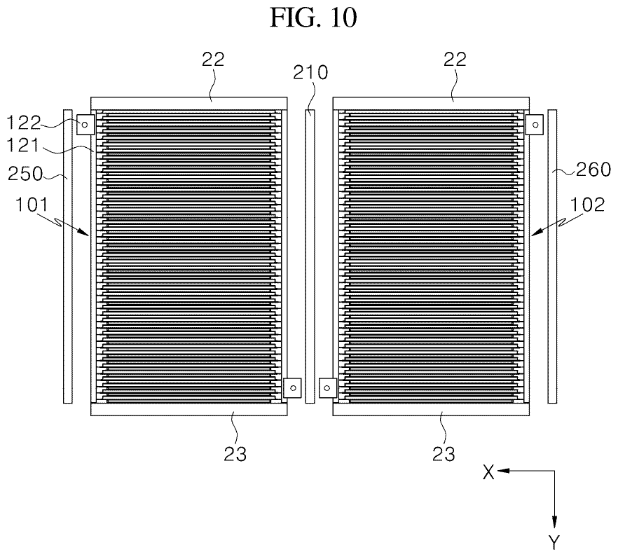

Referring to FIG. 10, the pair of sub-battery assemblies 101 and 102 coupled with the assembly jig 20 may be moved to be coupled with the case assembly 200. For example, the first sub-battery assembly 101 and the second sub-battery assembly 102 may be assembled separately. The sub-battery assemblies 101 and 102 may be arranged in a row. For example, the sub-battery assemblies 101 and 102 may be spaced apart from each other in the front-back direction.

The pair of sub-battery assemblies 101 and 102 coupled with the assembly jig 20 may be placed on the lower case 230. The front case 250 and the rear case 260 may be disposed on opposite sides of the pair of sub-battery assemblies 101 and 102, each coupled with the assembly jig 20.

For example, the front case 250 may be disposed in front of the first sub-battery assembly 101, which is one of the pair of sub-battery assemblies 101 and 102. The rear case 260 may be disposed behind the second sub-battery assembly 102, which is the other of the pair of sub-battery assemblies 101 and 102.

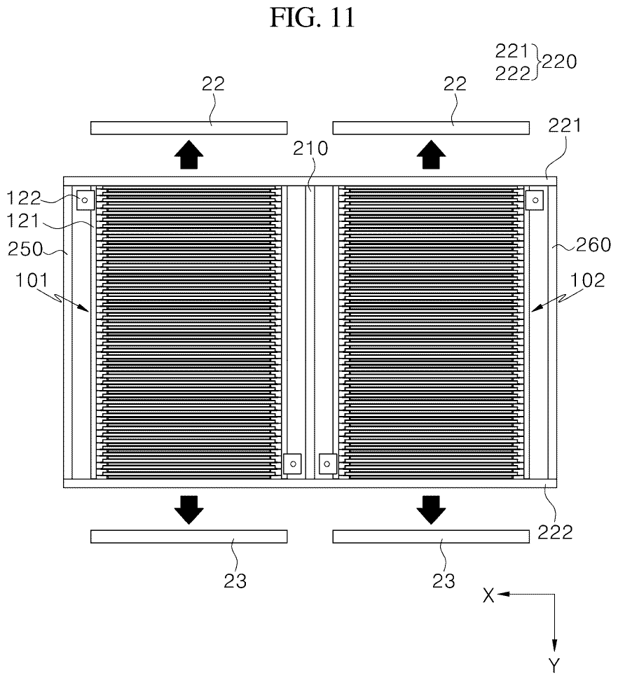

Next, referring to FIG. 11, prior to coupling the side case 220 to the pair of sub-battery assemblies 101 and 102, the assembly jig 20 coupled to the pair of sub-battery assemblies 101 and 102 may be removed. For example, the left panel 22 of the assembly jig 20 and the right panel 23 of the assembly jig 20 may be separated from the sub-battery assemblies 101 and 102. When the left panel 22 of the assembly jig 20 and the right panel 23 of the assembly jig 20 are removed, the compressed sub-battery assemblies 101 and 102 may expand in the stacking direction of the battery cells 111. Meanwhile, the busbar assembly 120 may prevent the expansion of the sub-battery assemblies 101 and 102.

The first side case 221 and the second side case 222 may be coupled to the pair of sub-battery assemblies 101 and 102, respectively. The side cases 220 may be disposed on opposite lateral sides of the pair of sub-battery assemblies 101 and 102 extending in the front-back direction. The first side case 221 may be coupled along the left sides of the pair of sub-battery assemblies 101 and 102. The first side case 221 may be coupled to the left ends of the front case 250 and the rear case 260.

The second side case 222 may be coupled along the right sides of the pair of sub-battery assemblies 101 and 102. The second side case 222 may be coupled to the right ends of the front case 250 and the rear case 260.

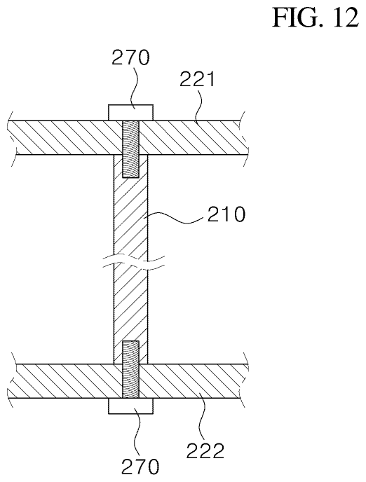

Hereinafter, a joining structure between the center case 210 and the side case 220 will be described with reference to FIGS. 12 to 14. The center case 210 and the side case 220 forming the case assembly 200 may be coupled without gaps or misalignment.

Referring to FIG. 12, the center case 210 and the side case 220 may be joined using coupling members 270. The coupling members 270 may penetrate both sides of the side case 220. The coupling members 270 may penetrate both sides of the first side case 221 or both sides of the second side case 222.

The coupling members 270 may be connected or coupled to the side surface of the center case 210. For example, the coupling member 270 may be coupled to the side surface of the center case 210 by penetrating the first side case 221 or the second side case 222. For example, the coupling member 270 may be coupled to the surface of the center case 210 by press-fitting or a similar method.

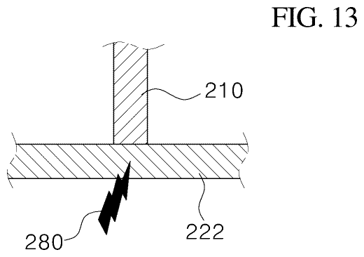

Referring to FIG. 13, the center case 210 and the side case 220 may be joined using a welding unit 280. The welding unit 280 may weld the side case 220 and the center case 210. The welding unit 280 may weld the contact portion between the side case 220 and the center case 210.

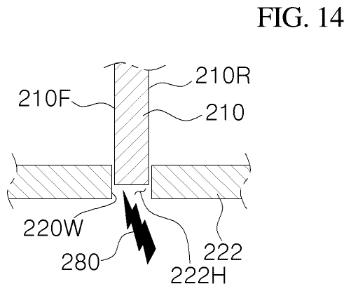

Referring to FIG. 14, the center case 210 and the side case 220 may be joined using a welding unit 280. The welding unit 280 may perform welding at a case hole 222H formed in the side case 220.

Both end portions of the center case 210 may be inserted into the case hole 222H formed in the second side case 222. The end of the center case 210 inserted into the case hole 222H and a wall 220W of the case hole 222H may be welded together using the welding unit 280.

The 220W can face or be oriented towards the case hole 222H. For example, The wall 220W of the case hole 222H may define a boundary of the case hole 222H. The wall 220W of the case hole 222H may contact or abut against a front surface portion 210F or a rear surface portion 210R of the center case 210 that is inserted into the case hole 222H.

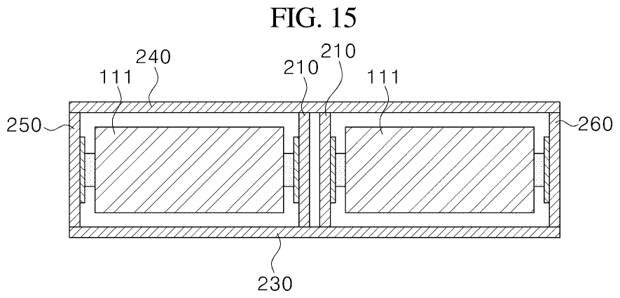

Referring to FIG. 15, the case assembly 200 may include a plurality of center cases 210. For example, a pair of center cases 210 may be provided. The pair of center cases 210 may be spaced apart from each other in one direction. For example, the pair of center cases 210 may be spaced apart in the longitudinal direction of the battery module 10.

One of the pair of center cases 210 may be adjacent to the first sub-battery assembly 101. The other of the pair of center cases 210 may be adjacent to the second sub-battery assembly 102.

One of the pair of center cases 210 and the front case 250 may form a space for the first sub-battery assembly 101. The other of the pair of center cases 210 and the rear case 260 may form a space for the second sub-battery assembly 102.

Referring to FIGS. 7 to 15, a method for manufacturing a battery module may include: mounting a cell assembly 110, in which battery cells 111 are stacked, onto an assembly jig 20; coupling a busbar assembly 120 to the cell assembly 110 to form a sub-battery assembly; arranging a pair of sub-battery assemblies 101 and 102 spaced apart from each other in a front-back direction; removing a left panel 22 and a right panel 23 of the assembly jig 20 disposed on both sides of the cell assembly 110 in the stacking direction of the battery cells; and arranging side cases 220 on side surfaces of the pair of sub-battery assemblies 101 and 102 in the front-back direction.

The method may further include arranging a center case 210 between the sub-battery assemblies 101 and 102, wherein the center case 210 may be coupled to the side cases 220.

While the battery module and the method for manufacturing the battery module according to the embodiments of the present disclosure have been described in detail with reference to specific embodiments, these are merely illustrative. The present disclosure is not limited thereto, and should be construed to cover the broadest scope consistent with the basic concepts disclosed herein.

What is claimed is:

1. A battery module comprising:
a plurality of sub-battery assemblies spaced apart from each other in a front-back direction; and
a case assembly configured to accommodate the plurality of sub-battery assemblies,
wherein the case assembly is formed to extend in the front-back direction and comprises a side case that forms a side surface of the case assembly, and
the side case is disposed on the side surfaces of the plurality of sub-battery assemblies.

2. The battery module according to claim 1, wherein the side case comprises:
a first side case disposed on one side of the plurality of sub-battery assemblies; and
a second side case disposed on the other side of the plurality of sub-battery assemblies.

3. The battery module according to claim 1, wherein the plurality of sub-battery assemblies comprise:
a first sub-battery assembly; and
a second sub-battery assembly disposed behind the first sub-battery assembly in the front-back direction.

4. The battery module according to claim 1, wherein each of the side cases is formed as a single integrated member.

5. The battery module according to claim 1, wherein the case assembly comprises:
a center case disposed between the plurality of sub-battery assemblies,
wherein the center case is coupled to the side case.

6. The battery module according to claim 3, wherein the case assembly further comprises:
a lower case disposed below the plurality of sub-battery assemblies;
an upper case disposed above the plurality of sub-battery assemblies;
a front case disposed in front of the first sub-battery assembly; and
a rear case disposed behind the second sub-battery assembly.

7. The battery module according to claim 1, wherein each of the plurality of sub-battery assemblies comprises:
a cell assembly having a plurality of battery cells stacked in a left-right direction; and
at least one busbar assembly coupled to the cell assembly.

8. The battery module according to claim 7, wherein the at least one busbar assembly comprises:
a busbar coupled to the cell assembly in the left-right direction; and
a busbar jig configured to join the busbar and the cell assembly.

9. The battery module according to claim 8, wherein a pair of busbar assemblies are provided, and
the pair of busbar assemblies are disposed in front and behind the cell assembly in the front-back direction.

10. The battery module according to claim 9, wherein the pair of busbar assemblies are symmetrically arranged with respect to the cell assembly.

11. The battery module according to claim 7, wherein each of the plurality of battery cells comprises:
a cell body that defines an external appearance of the battery cell; and
battery cell tabs formed on both sides of the cell body in a longitudinal direction of the battery cell.

12. The battery module according to claim 11, wherein the cell assembly further comprises cell pads disposed between the plurality of battery cells and stacked in the left-right direction.

13. The battery module according to claim 5, wherein a plurality of center cases are provided, and
the plurality of center cases are spaced apart from each other in the front-back direction.

14. The battery module according to claim 5, wherein the center case and the side case are coupled by welding.

15. The battery module according to claim 14, wherein one end of the center case is inserted into a case hole that penetrates the side case, and
a wall of the case hole facing the inserted end of the center case is welded to the inserted end.

16. The battery module according to claim 1, wherein, prior to coupling the side case to the sub-battery assembly, an assembly jig coupled to the sub-battery assembly is removed.

17. A method for manufacturing a battery module comprising:
mounting a cell assembly, in which battery cells are stacked, onto an assembly jig;
coupling a busbar assembly to the cell assembly to form a sub-battery assembly;
arranging a pair of sub-battery assemblies spaced apart from each other in a front-back direction;
removing a left panel and a right panel of the assembly jig disposed on both sides of the cell assembly in the stacking direction of the battery cells; and
arranging side cases on side surfaces of the pair of sub-battery assemblies in the front-back direction.

18. The method for manufacturing a battery module according to claim 17, further comprising arranging a center case between the sub-battery assemblies,
wherein the center case is coupled to the side cases.

19. The method for manufacturing a battery module according to claim 18, wherein the center case and the side case are coupled by welding.

20. The method for manufacturing a battery module according to claim 19, wherein one end of the center case is inserted into a case hole formed in the side case, and
a wall of the case hole facing the inserted end of the center case is welded to the inserted end.
